(19) United States
(12) Patent Application Publication
(10) Pub. No.: US 2003/0218690 A1
(43) Pub. Date: Nov. 27, 2003

(54) PERIPHERAL APPARATUS OF COMPUTER APPARATUS

(76) Inventor: YUJI SAKAEGI, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 08/579,739

(22) Filed: Dec. 28, 1995

(30) Foreign Application Priority Data
Dec. 28, 1994 (JP) 6-328495

(51) Int. Cl. H04N 5/225

(52) U.S. Cl. 348/372; 348/552

(57) ABSTRACT

Peripheral apparatus of a computer apparatus is constructed by a detecting unit for detecting a voltage level of a signal line connected to a personal computer, a power supply control unit for controlling a supply of an electric power from a power source to a predetermined circuit in accordance with an output of the detecting unit, a communication request discriminating unit for judging whether a communication request of a predetermined procedure has been transmitted from the personal computer after the electric power of the power source was supplied to a predetermined power consumption unit by the power supply control unit or not, and a control unit for deciding the power supply executed by the power supply control unit on the basis of the judgment result of the communication request discriminating unit.

### BACKGROUND OF THE INVENTION

1. Field of the Invention

The present invention relates to peripheral apparatus which is connected to a personal computer and, more particularly, to peripheral apparatus suitable for a personal computer that is driven by a battery.

2. Related Background Art

Hitherto, as peripheral apparatus of a personal computer (called a “PC”) which is driven by a battery, various peripheral apparatus have been put into practical use and, for example, there is peripheral apparatus of the personal computer called a “pocket modem”.

Such a pocket modem has not only a data transfer line but also a unique control line for controlling a supply of power source and the like in order to control a power source from the personal computer side in accordance with the necessity.

It is, however, uneconomical that a signal line for a purpose other than the data transfer is provided between the personal computer and the pocket modem in order to control the power source.

For example, among interfaces which an IBM-PC compatible machine has as standard interfaces, an I/F having a relatively high data transfer speed is a parallel I/F. However, a target signal line for the power control is not allocated to the parallel I/F. It is, therefore, difficult to control a power source of external apparatus by an exclusive-use signal.

In the peripheral apparatus of the personal computer which is driven by a battery power source, when the power source is always supplied to the peripheral apparatus during the connection with the personal computer, since a battery capacity is remarkably consumed, there is a problem such that it is uneconomical.

In general, therefore, the conventional peripheral apparatus of the personal computer is constructed so as to turn off the power source when there is no transmission/reception of data between the personal computer and the peripheral apparatus for a predetermined time.

In case of constructing as mentioned above, however, after the power source was automatically turned off, if the user wants to use the apparatus again, the user has to again manually turn on the power source of the peripheral apparatus, so that there is a problem of inconvenience.

### SUMMARY OF THE INVENTION

The invention is made to solve the above problems and a first object of the invention is to improve an efficiency of a power control in a personal computer to which peripheral apparatus is connected.

A second object of the invention is to automatically control a power supply in accordance with an operating state of peripheral apparatus connected to a personal computer.

In order to achieve the objects, according to a preferred embodiment of the invention, there is provided peripheral apparatus of a computer apparatus, comprising: detecting means for detecting a voltage level of a signal line connected to a personal computer; power supply control means for controlling a supply of an electric power from a power source to a predetermined circuit in accordance with an output of the detecting means; communication request discriminating means for judging whether a communication request of a predetermined procedure has been transmitted from the personal computer after the electric power of the power source was supplied to a predetermined power consumption unit by the power supply control means or not; and control means for deciding the power supply executed by the power supply control means.

According to another preferred embodiment of the invention, there is provided peripheral apparatus of a personal computer, in which the power source is supplied only under a predetermined condition such that states of voltage levels of a plurality of output ports of the personal computer have been predetermined, a predetermined communicating procedure is confirmed with the personal computer when the power source is supplied, the power source can be certainly supplied only when it is necessary, the electric power can be immediately shut off when it is unnecessary, it can be prevented that the electric power is consumed in vain, and the power supply to the peripheral apparatus can be certainly controlled by merely activating a software on the personal computer side by the user.

The above and other objects and features of the present invention will become apparent from the following detailed description and the appended claims with reference to the accompanying drawings.

### BRIEF DESCRIPTION OF THE DRAWINGS

FIG. 1 is a functional constructional diagram showing an embodiment of peripheral apparatus of the invention;

FIG. 2 is a block diagram showing a specific example of the peripheral apparatus of the invention; and

FIG. 3 is a flowchart showing a processing procedure for a power supply in a system control unit.

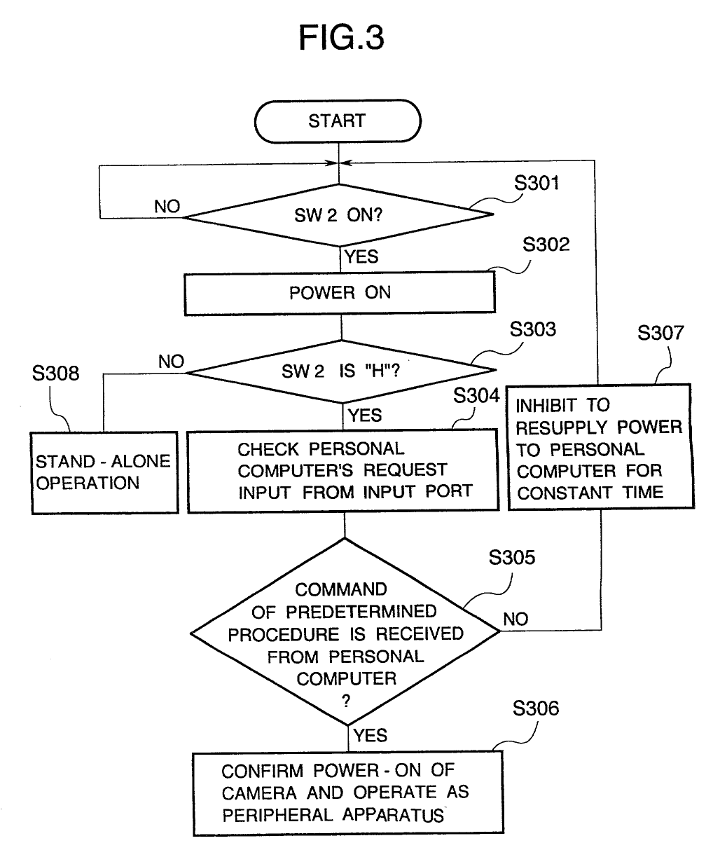

### DETAILED DESCRIPTION OF THE PREFERRED EMBODIMENTS

An embodiment of peripheral apparatus of a personal computer of the invention will now be described hereinbelow with reference to the drawings.

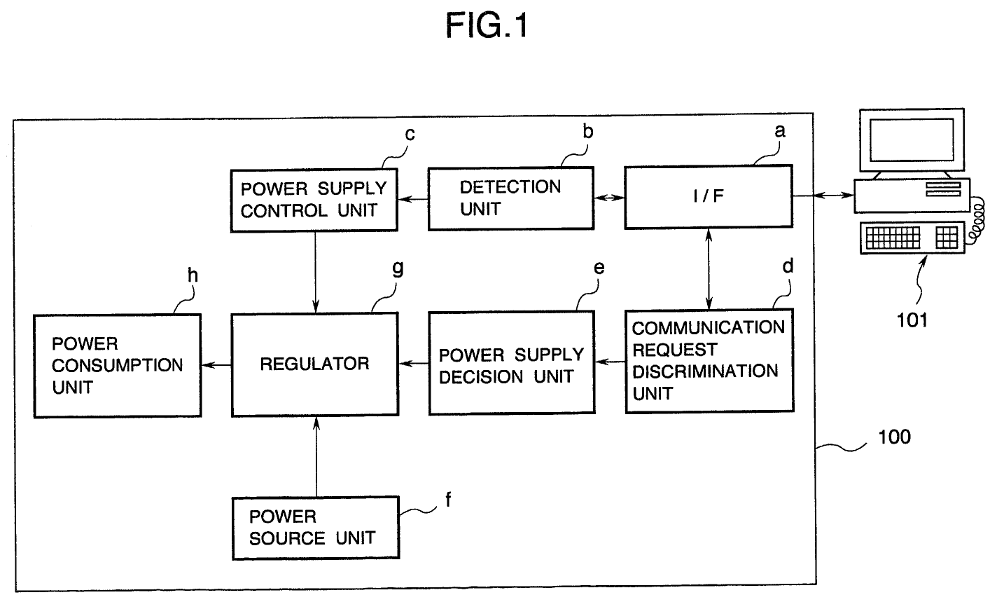

FIG. 1 shows a construction of the first embodiment of the invention. As shown in FIG. 1, peripheral apparatus 100 of the embodiment is used by connecting to a personal computer 101 and is constructed as follows.

The peripheral apparatus 100 is constructed by: an interface (I/F) (a); a detection unit (b); a power supply control unit (c); a communication request discrimination unit (d); a control unit (e); a power source unit (f); a regulator (g); and a power consumption unit (h) including circuits for executing various functions, an actuator, and the like.

The interface (I/F) (a) inputs/outputs information between the peripheral apparatus 100 and the personal computer 101.

The detection unit (b) detects a logic level of a signal line connected to the personal computer 101. When the detected logic level coincides with a predetermined combination of predetermined logic levels, the detection unit (b) outputs a detection signal indicative of such a fact.

The power supply control unit (c) controls so as to supply the power source to the power consumption unit (h) on the basis of the detection output of the detection unit (b).

The communication request discrimination unit (d) judges whether a communication request of a predetermined procedure has reached from the personal computer 101 after the power source was supplied to the predetermined power consumption unit (h) by the power supply control unit (c) or not.

The control unit (e) decides the power supply executed by the power supply control unit (c) on the basis of the judgment result of the communication request discrimination unit (d).

The regulator (g) supplies the electric power supplied from the power source unit (f) to the power consumption unit (h) while being controlled by the power supply control unit (c) and control unit (e).

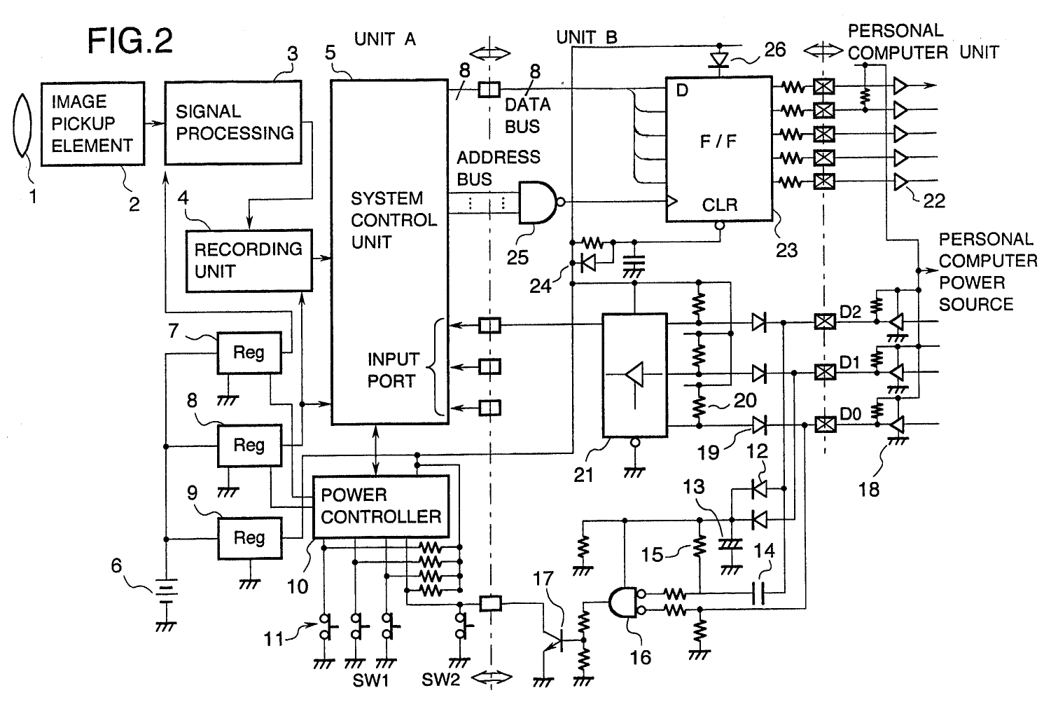

A specific construction example of the peripheral apparatus 100 of the embodiment that is constructed as mentioned above will now be described with reference to a block diagram of FIG. 2. An electronic camera is used as peripheral apparatus of the embodiment.

In FIG. 2, reference numeral 1 denotes a photographing lens on which a photographed image is optically formed; 2 an image pickup element (CCD) for converting the pickup image into an electric signal; and 3 a signal processing unit for converting an output of the image pickup element 2 into a video signal and also into a format which can be recorded into a recording medium.

Reference numeral 4 denotes a recording unit for recording a video signal; 5 a system control unit comprising a microcomputer for controlling the whole peripheral apparatus 100 of the embodiment; 6 a battery for supplying a power source to the whole peripheral apparatus; 7 a power regulator for supplying an operation power source to an image pickup section (image pickup element 2 and signal processing unit 3) corresponding to the power consumption unit (h) shown in FIG. 1; 8 a power regulator for supplying an operation power source to the recording unit 4; 9 a power regulator for supplying an operation power to a power controller 10; and 11 an operation switch having switches SW1 and SW2.

Reference numeral 12 denotes a diode connected to a signal line from the personal computer; 13 a capacitor; 14 a capacitor; and 15 a resistor element. A circuit for differentiation is constructed by the capacitor 14 and resistor element 15.

Reference numeral 16 indicates an NOR gate; 17 a transistor for controlling the power controller 10 in accordance with an output of the NOR gate 16; 18 an output buffer for outputting a signal on the personal computer 101 side; and 19 a diode for blocking an inflow of a current from an output of the output buffer 18.

Reference numeral 20 denotes a pull-up resistor for supplying a signal of the “H” level to a buffer 21; 21 the input buffer for receiving a signal from the personal computer 101; 22 an input buffer for receiving a signal from the peripheral apparatus in the personal computer 101; and 23 an output port for receiving a signal from the system control unit 5 and transmitting the signal to the personal computer 101.

Reference numeral 24 indicates a clear signal output circuit (Power Up Clear: PUC) for generating a clear signal for clearing the output port 23; 25 an address decoder for generating a write signal to the output port 23; and 26 a Schottky-barrier diode (SBD) for supplying a power source to the output port 23.

The peripheral apparatus 100 for the personal computer of the embodiment constructed as mentioned above operates as an electronic camera when it is not connected to the personal computer 101. That is, in case of only a unit (A) shown in FIG. 2 (without a unit (B) and the personal computer 101), when the release button SW2 is depressed, the power controller 10 detects the depression of the release button SW2, operates the power regulator 8, and starts the supply of the power source to the system control unit 5.

The system control unit 5 detects the depression of the release button SW2 by obtaining the information from the power controller 10. The system control unit 5 subsequently gives an instruction to the power controller 10 and activates the power regulator 7, thereby supplying the power source to the image pickup element 2 and signal processing unit 3 of the image pickup section.

After that, the system control unit 5 controls the image pickup element 2, and signal processing unit 3 of the image pickup section, and the recording unit 4. The electric signal converted from an optical image is recorded into the recording unit 4. After finishing the recording operation, the system control unit 5 again checks the depression of the release button SW2. When it is depressed, the photographing is performed again. When it is not depressed, the power source is shut off. The above operations are executed when the peripheral apparatus 100 operates as an electronic camera.

The operation when transferring the image information recorded in the recording unit 4 to the personal computer 101 will now be described hereinbelow.

The user connects the unit A (electronic camera main body section) and the personal computer 101 through the unit B. The personal computer 101 shown in FIG. 2 is a circuit portion of parallel ports of a general IBM-PC and compatibles.

After the electronic camera of the embodiment and the personal computer 101 were connected as shown in FIG. 2, the user activates an exclusive-use software on the personal computer 101 side. The software activated as mentioned above tries to communicate with the system control unit 5 by accessing the parallel ports.

When the process is started, a check is made to see whether the release button SW2 has been turned on or not in step S301. W the power source of the unit A is shut off, the system control unit 5 naturally cannot respond to the communication from the personal computer 101. The software on the personal computer 101 side outputs signals of the “H”, “H”, and “L” levels to three bits of terminal units D2, D1, and D0 of the signal lines, respectively, thereby allowing charges to be accumulated in the capacitor 13 through the diode 12.

At about a timing when the charges have been accumulated in the capacitor 13, the software outputs signals of the “L”, “H”, and “L” levels to the terminal units D2, D1, and D0 of the signal lines, respectively. Since the charges are accumulated in the capacitor 13, a sufficient power source is supplied to the NOR gate 16.

In this case, since the signal level changes like D2=“H”→“L” in a state in which the terminal unit DO of the signal line is set to the “L” level, a potential difference occurs across the capacitor 14 and a current flows in the resistor element 15. Consequently, both of two input terminals of the NOR gate 16 are set to the “L” level and the NOR gate 16 generates a signal of the “H” level.

Thus, the transistor 17 is turned on and the same state as that when the release button SW2 was depressed occurs. In this case, the processing routine advances to step S2 and the power controller 10 operates the power regulator 8, thereby supplying the power source to the system control unit 5. By a differentiating operation of the capacitor 14 and resistor element 15, however, the release button SW2 is set to the “L” level only for a short time.

That is, turn-on of the transistor Tr 17 by control of a PC (personal computer) is a turn-on operation caused for a short time by a filter circuit formed by the capaciter.

On the other hand, in the case that an operator turns on the transistor Tr 17 by operating the release button SW2, it can be assumed that the transistor Tr 17 may be turned on for a long time, and thus the flow chart of the present embodiment includes a discrimination step for discriminating a control signal from the PC and a signal caused by the operation of the release button SW2 by the operator, based upon length of turn-on time of the transistor Tr 17.

The power controller 10 again checks the port of the release button SW2 after the elapse of a predetermined time since the release button SW2 was set to the “L” level and the regulator 9 was turned on (step S303).

When the release button SW2 is at the “L” level in this instance, it is judged that the release button SW2 was depressed by a human finger and the processing routine advances to step S308. The power controller 10 operates as a stand-alone controller which is not connected to the personal computer 101.

On the other hand, when the release button SW2 is set to the “H” level as a result of the discrimination in step S303, the power controller 10 judges that the release button SW2 is not operated by the human finger but was closed by the circuit in the unit B. In this case, the processing routine advances to step S304 and such information is sent to the system control unit 5.

The system control unit 5 receives the information and checks signals inputted from the personal computer 101 to the input ports through the buffer 18 and input buffer 21. The processing routine advances to step S305 and a check is made to see whether a communication request of a predetermined procedure has been received from the personal computer 101 or not.

If the communication request of the predetermined procedure has been received from the personal computer 101 side as a result of the discrimination in step S305, step S306 follows and the system control unit 5 decides the supply of the power source.

If NO in step S305, the system control unit 5 judges that the supply of the power source is an accidental result. The processing routine advances to step S307 and an instruction to inhibit the resupply of the power for a predetermined time is sent to the power controller 10.

The system control unit 5 outputs data to the output port 23 and outputs a signal responding to the communication to the personal computer 101. The software on the personal computer 101 side receives the signal through the input port 22 and confirms that the power source of the unit A on the camera side was turned on.

Subsequently, the software on the personal computer 101 side outputs a “data transfer request” to the camera through the output buffer 18. The request is made to transfer the image data obtained by photographing an object by the camera and stored in the recording unit 4 to the personal computer 101.

When the request signal is received, the system control unit 5 reads out the data from the recording unit 4 and transfers the data to the personal computer 101 side through the output port 23.

The software on the personal computer 101 side reads out the signal from the input port 22, temporarily stores into a memory and, after that, displays the data on a picture screen as necessary or records the signal into memory means such as a hard disk or the like.

When the execution of the software which needs the camera is finished on the basis of the operation of the user on the personal computer 101 side, the software on the personal computer 101 side transmits a command of power shut-off to the system control unit 5 through the output port 18. When the command is received, the system control unit 5 sends an instruction to the power controller 10, thereby turning off the regulator 9.

In the peripheral apparatus constructed in a manner such that the power source can be supplied from the personal computer side as mentioned above, the power source is supplied only under a predetermined condition such that states of the voltage levels of the plurality of output ports of the personal computer have been predetermined, the predetermined communicating procedure is confirmed with the personal computer when the power source is turned on, the power source can be certainly supplied only when it is necessary, and the electric power can be immediately shut off when it is unnecessary.

Consequently, it can be prevented that the electric power is consumed in vain, and the power supply to the peripheral apparatus can be certainly controlled by merely activating the software on the personal computer side by the user, so that the user doesn't need to operate the power source of the peripheral apparatus each time and the peripheral apparatus of the personal computer having a good use efficiency and a power-saving performance can be provided.

Even when a software which causes substantially the same signal transition state as that of the turn-on of the power supply accidentally operates on the personal computer side, such a situation can be accurately detected and when the software accidentally operates, the power supply is inhibited for a predetermined time, so that it is possible to prevent that the electric power is consumed in vain.

What is claimed is:

1. Peripheral apparatus which can be connected to computer apparatus, comprising:
detecting means for detecting a voltage level of a signal line connected to a personal computer;
power supply control means for controlling a supply of an electric power from a power source to a predetermined circuit in accordance with an output of said detecting means;
communication request discriminating means for judging whether a communication request of a predetermined procedure has been received from the personal computer after the electric power of the power source was supplied to a predetermined power consumption unit by said power supply control means or not; and
control means for deciding the power supply executed by said power supply control means on the basis of the judgment result of said communication request discriminating means.

2. Apparatus according to claim 1, wherein said detecting means detects a logic level of a data line arranged between said personal computer and said periphery apparatus and said communication request discriminating means detects the presence or absence of the communication request at said logic level detected by said detecting means.

3. An apparatus according to claim 2, wherein said data line and a line for the power supply are separately provided.

4. An apparatus according to claim 1, wherein said peripheral apparatus is an electronic camera.

5. An apparatus according to claim 4, wherein said communication request discriminating means judges whether said electronic camera has been operated by an operator or controlled by the personal computer or not, and said control means executes a control in accordance with a result of said judgment.

6. An apparatus according to claim 2, wherein said detecting means and discriminating means use the signal level transmitted through said data line as a power source.

7. A camera which can be connected to computer apparatus, comprising:
recording means for recording a photographed image;
detecting means for detecting a level of a data line which is connected to a personal computer;
discriminating means for judging whether an input signal is a predetermined command from said personal computer or not in accordance with an output of said detecting means;
image output means for outputting image data recorded by said recording means to said personal computer; and
control means for controlling a power supply to said recording means and said image output means in accordance with a judgment result of said discriminating means.

8. A camera according to claim 7, wherein said detecting means detects a logic level of the data line arranged between said personal computer and said camera and said discriminating means detects the presence or absence of a communication request at said logic level detected by said detecting means.

9. A camera according to claim 7, wherein said data line and a line for the power supply are separately provided.

10. A camera according to claim 7, wherein said recording means has a buffer for storing the photographed image information.

11. A camera according to claim 7, wherein said detecting means and said discriminating means use the signal level transmitted through said data line as a power source.
